(19) United States
(12) Patent Application Publication
(10) Pub. No.: US 2007/0268480 A1
(43) Pub. Date: Nov. 22, 2007

(54) Bed angle sensor for reducing ventilator-associated pneumonia

(76) Inventor: Mitchell G. Kaye, Minnetonka, MN (US)

Correspondence Address: KLEHR , HARRISON ET AL, 260 S. BROAD STREET, PHILADELPHIA, PA, 19102, US

(21) Appl. No.: 11/436,433

(22) Filed: May 18, 2006

(51) Int. Cl. G01B 11/26; G01C 9/06

(52) U.S. Cl. 356/138; 33/366.11

(57) ABSTRACT

Apparatus for indicating the angular position of a patient support surface such as a mattress relative to the direction of gravity is disclosed. An angle sensor mounted to a frame associates with the patient support surface to create an output responsive to changes in position relative to gravity. Circuitry transmits an output signal to activate a display of the angular position of the patient support, thereby indicating whether the angular position is within a predetermined range. Preferably, the apparatus has a circuit for activating an indicator light, which more preferably mounted above the patient support surface. In certain preferred embodiments the apparatus that comprises the light is connected to the headboard, or the like. It is preferred that the apparatus has a memory device for storing positional information comprising at least a predetermined angular measurement, and more specifically that there is a device for storing information pertaining to the length of time said patient support has been set to an angular position is within a predetermined range.

The present invention relates to medical devices for patient care and monitoring and more specifically relates to methods and apparatus for hospital beds and the like.

### BACKGROUND OF THE INVENTION

Critically ill patients on mechanical ventilation in the Intensive Care Unit (ICU) are at high risk for developing a variety of nosocomial (hospital-acquired) infections. The most common of these infections is ventilator-associated pneumonia, which complicates the course of almost 30% of patients undergoing mechanical ventilation. Patients with ventilator-associated pneumonia have a mortality rate that approaches 50%. Ventilator-associated pneumonia also results in a prolonged duration of mechanical ventilation, increased length of ICU stay and higher healthcare costs.

The pathogenesis of ventilator-associated pneumonia is generally recognized to consist of two steps: 1) bacterial colonization of the stomach and oropharynx, and 2) subsequent pulmonary aspiration of contaminated secretions. Mechanically ventilated patients are prone to gastric bacterial colonization due to the widespread use of histamine-2 (H2) receptor blockers and proton pump inhibitors for the prevention of gastrointestinal stress ulceration. Indwelling nasogastric and nasoenteric feeding tubes decrease the competence of the lower esophageal sphincter, increasing the potential for aspiration. Strategies to reduce the incidence of ventilator-associated pneumonia are typically aimed at reducing the colonization of the aerodigestive tract, decreasing the incidence of aspiration, or both. Because gastroesophageal aspiration is facilitated by supine body position, it is recommended that the head of a patient's bed be elevated to about 30-45 degrees at all times, as clinically tolerated, to reduce aspiration of contaminated secretions and subsequent development of ventilator-associated pneumonia.

Thus, maintenance of the head of the bed at about 30-45 degrees is a clinically useful method for reducing a patient's risk of ventilator-associated pneumonia and ICU mortality. These concepts are well developed in the literature, see for example, Kollef et al., “The prevention of ventilator-associated pneumonia.” NEJM 1999; 340:627-634; Dodek et al., “Evidence-based clinical practice guideline for the prevention of ventilator-associated pneumonia.” Ann Intern Med 2004; 141:305-313. Based on these and numerous other studies, the Centers for Disease Control and Prevention recommends that patients receiving mechanical ventilation have the head of the bed elevated between about 30 degrees and 45 degrees to prevent nosocomial pneumonia. However, use of higher backrest positions for critically ill patients is not a common nursing practice. Backrest elevation may be affected by the accuracy of nurses' estimates of patients' positions. Current recommended practice is summarized in: “Getting Started Kit: Prevent Ventilator-Associated Pneumonia” a copy of which is available at the website: http://www.ihi.org/NR/rdonlyres/A448DDB1-E2A4-4D13-8F02-16417EC52990/0/VAPHowtoGuideFINAL.pdf

Despite evidence of the effectiveness of this simple intervention, mechanically ventilated ICU patients are commonly not maintained at a head-of-bed angle that decreases their risk for the development of ventilator-associated pneumonia. See “Effect of Standardized Orders and Provider Education on Head-of-Bed Positioning in Mechanically Ventilated Patients.” Helman et al. Crit Care Med 31(9):2285-2290, 2003. In recognition of this fact, a device was recently developed that provides a simple indicator mounted to the side of a bed that uses a weight hanging from a thread to visually confirm whether the head of the bed is elevated at precisely 30 degrees. See Chest Physician, February 2006, p. 8. The disclosed device requires a clear view and adequate lighting and must be visually checked on a regular basis.

Numerous systems for controlling and providing data regarding the position of a patient relative to the vertical (or horizontal) are known. These systems are often complicated electromechanical devices that use feedback from pressure sensors and similar devices to adjust both the position of the bed as well as the contours and firmness of the bed surface (usually an air or fluidized bead mattress). For example, U.S. Pat. No. 6,353,950—Bartlett, et al. discloses a positional feedback system for a medical mattress. The apparatus adjusts the pressures of a therapeutic mattress surface in accordance with the angular position of that surface and has both an angular position sensor and a rotation sensor.

There remains, however, a long-felt and as of yet unmet need for a device that is both simple and robust that can verify that the angle of a patient's bed is within a certain criterion. Prior art devices are either overly complex and related to highly sophisticated bed systems, or are inadequate as monitoring devices particularly if the beds with which they are used are moved or are surrounded by other equipment, in dimly lit areas or other wise difficult to access from the side for an inspection of the angle. It would therefore be desirable to provide a system that has a visual indication of bed angle and that can be viewed in a variety of settings, e.g., while the patient is in a ward, in an ICU unit, in transit, in an elevator, etc. It would be further desirable to provide a device that is inexpensive and that can be part of a newly manufactured bed, or retrofitted into existing beds.

### SUMMARY OF THE INVENTION

Accordingly, it has now been found that the shortcomings of the prior art can be overcome by providing an apparatus for indicating the angular position of a patient support surface such as a mattress relative to the direction of gravity by mounting an an angle sensor to a frame associated with the patient support surface and having an output responsive to changes in the angle sensor's position relative to gravity, in which the angle sensor has circuitry for transmitting an output signal to activate a display of the angular position of the patient support to indicate whether the angular position is within a predetermined range. In certain embodiments, the angle sensor comprises an enclosure to house said angle sensor and an inclinometer having an output that correlates position to the direction of gravity. Preferably, the apparatus has a circuit for activating an indicator light, which more preferably is connected to the enclosure and mounted above the patient support surface. In certain preferred embodiments the apparatus comprises a headboard (or footboard) and the light is connected to the headboard (or footboard), but in certain embodiments the indicator light is remote from the enclosure, and may optionally use a wireless transmitter for transmitting a signal to activate the light. It is preferred that the apparatus has a memory device for storing positional information comprising at least a predetermined angular measurement, and more specifically that there is a device for storing information pertaining to the length of time said patient support has been set to an angular position is within a predetermined range.

Methods of indicating the angular position of a patient support surface relative to the direction of gravity are also disclosed. In accordance with the present invention an angle sensor is mounted to a frame associated with the patient support surface and an output responsive to changes in said angle sensor's position relative to gravity force is created. An output signal to activate a display of the angular position of said patient support is then transmitted and the display indicates whether the angular position is within a predetermined range, preferably by turning a light on or off.

The present invention also relates to methods of determining the angular position of a patient support surface relative to the direction of gravity, comprising: the steps by observing a display of the angular position of said patient support to indicate whether the angular position is within a predetermined range. Preferably, the step of observing a display comprises observing a light mounted either to a frame associated with the patent support surface or mounted to a remote light display and whether the light is turned on or turned off. Additionally, in certain preferred embodiments, the step of observing a display also comprises observing an indication of a time period during which the patent support surface has been positioned within a predetermined range, again preferably by observing whether a light is turned on or turned off.

### BRIEF DESCRIPTION OF THE DRAWINGS

FIG. 1 is a side elevation view of a typical hospital bed illustrating a preferred embodiment of the present invention;

FIG. 2 is a side elevation view of the bed illustrated in FIG. 1 showing the head of the bed elevated;

FIG. 3 is a side elevation view of another preferred embodiment of the present invention;

FIG. 4 is a schematic of a circuit used in preferred embodiments of the present invention; and

FIGS. 5A-5B are, respectively, a side elevation view of another preferred embodiment of the present invention and a remote indication system used in conjunction with this embodiment.

### DETAILED DESCRIPTION OF THE PREFERRED EMBODIMENTS

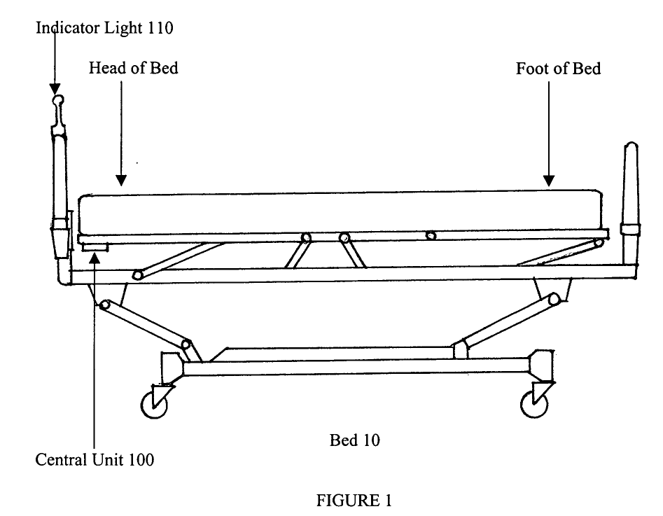

Referring now to FIG. 1, there is shown a typical hospital bed 10 that includes a frame that supports a patient support surface. In some instances, the patient support surface will be a mattress and in others it will be integrated with the frame. The present invention is useful with beds, but is similarly useful with other devices that support patients such as operation and examination tables, gurneys, carts and the like as well as transport structures built into transportation vehicles and the like.

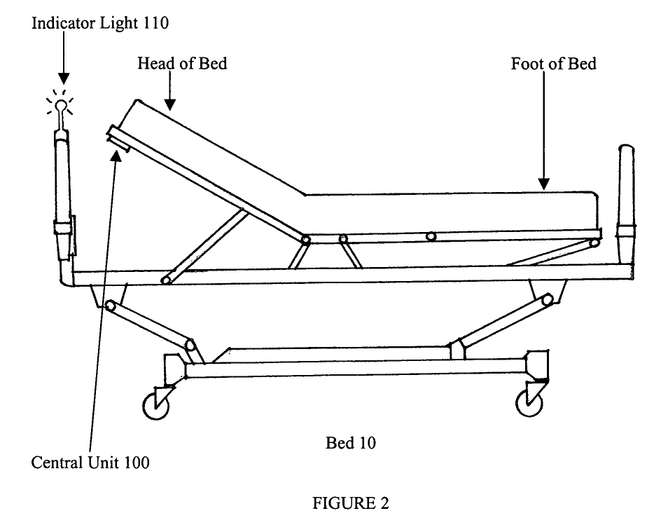

Still referring to FIG. 1, in accordance with the present invention, a central unit 100 is mounted to the frame of the bed 10. As shown, the central unit 100 is mounted underneath the head of the bed, however, the central unit 100 can be mounted to the side of the frame and as explained below can be mounted in other locations and is preferably secured in place with either Velcro strips or clamps. It is possible that in some applications the bed will be frameless or have internal support structures and thus the central unit will be affixed to the patient support surface itself. The central unit 100 preferably is made of radiolucent material and has a battery clip door to allow access for battery changes (in those embodiments that include a battery). The embodiment illustrated in FIG. 1 represents a preferred embodiment for maintaining a patient elevated at an angle such that the incidence of ventilator associated pneumonia is reduced. Referring now to FIGS. 1-2 it can be seen that the head of the bed is elevated and when elevated, an indicator light 110 is activated (or alternatively can be deactivated). In certain embodiments the indicator light will be activated only when the elevation angle is within a predetermined limit, either a narrow limit such as 29.5-30.5 degrees, or a broader limit such as 30-45 degrees. In other embodiments the indicator light will glow one color if the head of the bed is elevated to the correct angle and will glow another color when the angle is incorrect. Other indicator signals such as flashing lights or sound effects can also be included to alert personnel that the incorrect bed angle has been set. The present invention provides an advantageous monitoring system that is not unduly complex and is easily checked visually, yet because the indicator light 110 is mounted in a visible area, the side of the bed itself need not be inspected. The indicator light 110 can be mounted to either a footboard or headboard associated with the bed or may be remote from the bed, in the same room or in another room, on a wall above the bed or connected via a wired or wireless connection to any conceivable location and to any of a number of display devices included but not limited to dedicated monitoring panels, computer or other existing monitor screens or remote monitor screens or similar devices such as PDAs.

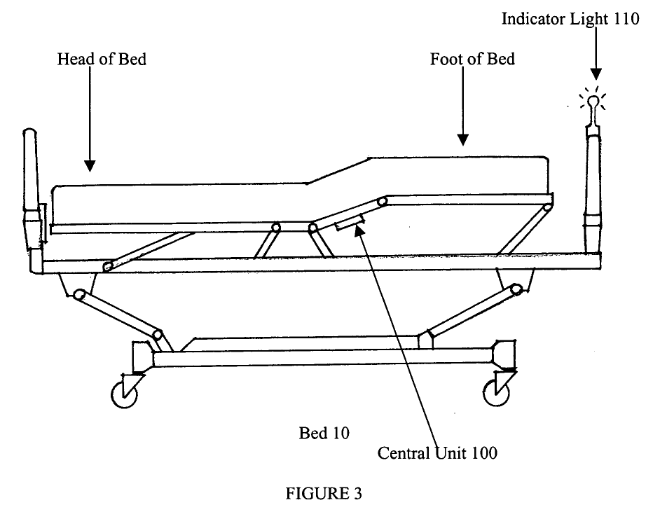

Referring now to FIG. 3 an alternate embodiment of the present invention is illustrated. The bed 10 is the same as shown in FIGS. 1-2; however, in this instance the central unit 100 is mounted in the central region of the bed and monitors the elevation angle of the thighs. As will be understood by those skilled in the art, in addition to ventilator associated pneumonia, there are myriad medical conditions that are treated by elevating a patient's limbs or trunk to a certain angle, and relevant to the embodiment illustrated in FIG. 3, it may be important to elevate the legs to reduce pressure, alter blood flow or reduce the incidence of ulcers, among other things.

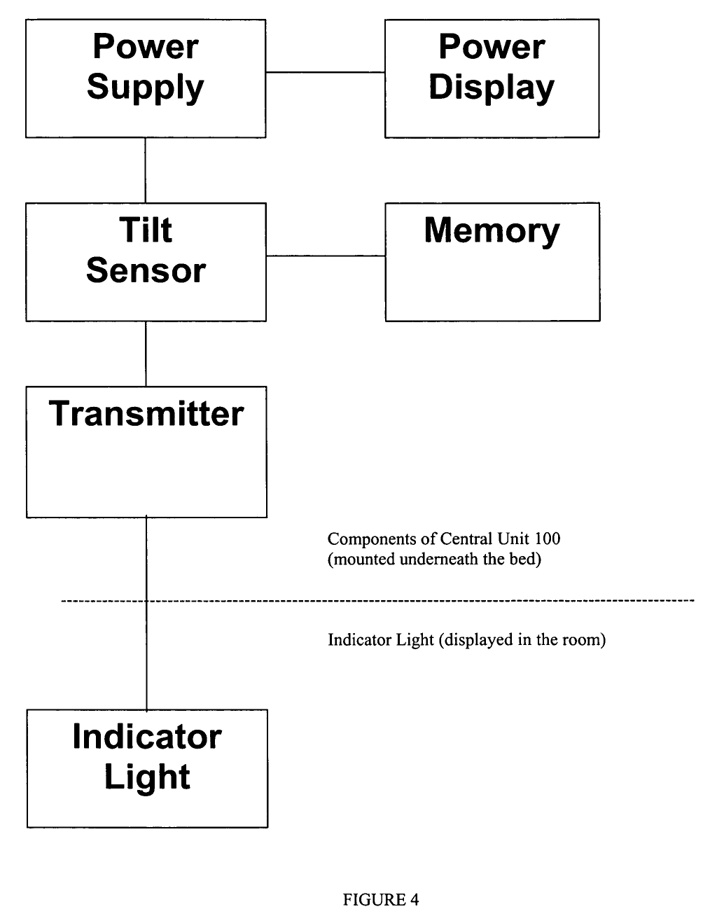

FIG. 4 is a schematic of a circuit used in certain preferred embodiments of the present invention. Generally, this circuit or parts of it will be contained within the central unit 100 illustrated in FIGS. 1-3. Preferably, the circuit will have a power supply, which can be either a storage cell (battery) or power generated by a power supply that is either part of the device or power taken from another power supply already existing on or in the bed or similar structure, typically DC current converted from an AC source. It is preferred that the power supply be as small as possible and have as long a life as possible. Preferably but not necessarily, the power supply is connected to a power display (which indicates the presence of power) and to the tilt sensor. The tilt sensor (or inclinometer) preferably includes a memory or equivalent electronic or electromechanical feature that allows a predetermined angle or angular range to be “set.” Additionally, in certain embodiments, the memory will determine and record the time spent at a certain angle, e.g., the time spent with the head of the bed elevated at the specified angle. Tilt sensors and their implementation in hospital beds are well known in the art. One useful type of sensor is discussed in http://sensors-transducers.globalspec.com/LearnMore/Sensors_Transducers_Detectors/Tilt_Sensing/Tilt_Inclinometers. An example of tilt switches that are commercially available at a variety of angles is disclosed at http://www.allproducts.com/ee/jinzonco/32-tilt_switches.html.

As discussed in further detail below, in certain embodiments, the indicator light 110 includes an LED or similar light that is easily visible from outside the room and can be mounted or attached to the bed and/or the ventilator. This is connected to the transmitter, via an output jack or by other means. As also discussed below, in certain embodiments wireless transmission to a remote light display is also included. In such wireless embodiments, a bedside monitor or central nursing station monitor is provided that indicates the status of the bed as being within or outside of the designated angle, (and data relating to the time set at that angle, if collected and/or if this feature is activated). The remote light display is attached to the central unit 100 by either a wire connected to the output jack, or via wireless transmission.

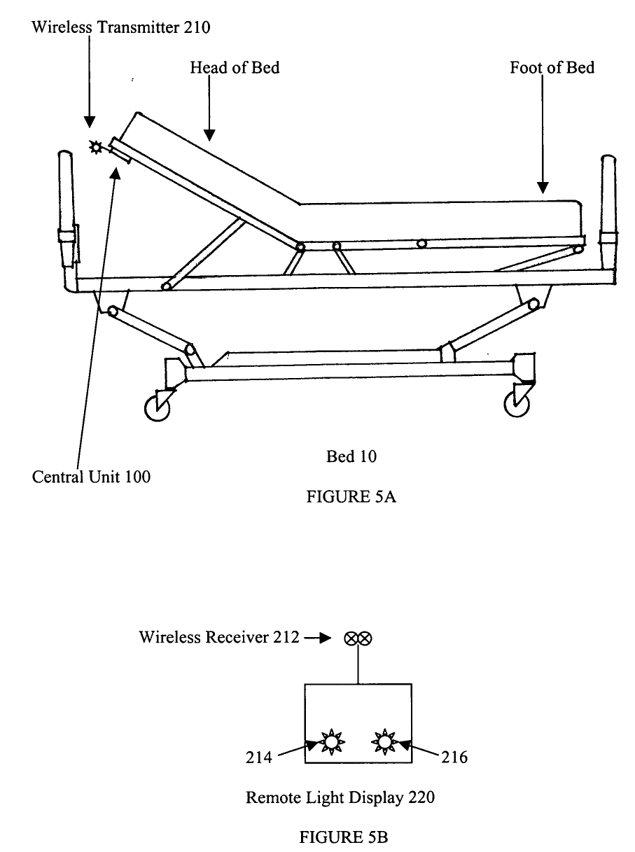

Referring now to FIG. 5A-5B, a wireless embodiment of the apparatus of the present invention is illustrated. In general the system illustrated is similar to that shown in FIGS. 1-2 and includes a central unit 100, which further includes a wireless transmitter 210, although as described above, a hard-wired connection may be included and a jack or other connector would replace the remote transmitter 210. As seen in FIG. 5B, a remote light display 220 would include a wireless receiver 212 (or hard-wired connection) that received a signal from the central unit 100. Indicator lights 214,216 provide information, such as whether the bed is elevated to the chosen angle and if the recommended time duration has been achieved.

Although certain embodiments of the present invention have been described with particularity, these embodiments are illustrative and do not limit the present invention. In particular, the present invention is not limited to a particular bed, gurney, cart or other patient handling device, nor is it limited to the specific conditions and angles illustrated and described. These embodiments are provided to enable one of skill in the art to make and use the invention. Upon review of the foregoing, numerous adaptations, modifications, and alterations will occur to those skilled in the art. These will all be, however, within the spirit of the present invention. Accordingly, reference should be made to the appended claims in order to ascertain the true scope of the present invention.

1. An apparatus for indicating the angular position of a patient support surface relative to the direction of gravity, comprising:
an angle sensor mounted to a frame associated with the patient support surface and having an output responsive to changes in said angle sensor's position relative to the direction of gravity, said angle sensor comprising circuitry for transmitting an output signal to activate a display of the angular position of said patient support surface, the circuitry comprising a circuit for activating an indicator light to indicate whether the angular position is within a predetermined range, wherein said indicator light comprises a base, an upwardly extending post and a light affixed to a distal end of said post, wherein the base is disposed upon a surface remote from the angle sensor, whereby the light is visible from a position remote from the patient support surface while looking in the direction of the patient support surface.

2. The apparatus according to claim 1, wherein said angle sensor comprises:
an enclosure to house said angle sensor; and
an inclinometer having an output that correlates position to the direction of gravity.

3. The apparatus according to claim 1, wherein the display is removably attached to the surface.

4. The apparatus according to claim 1 wherein said indicator light is connected to the enclosure and mounted above the patient support surface at a point remote from the enclosure so as to be visible from a remote location while looking in the direction of the patient support surface.

5. The apparatus according to claim 4 wherein the apparatus comprises a headboard or footboard, and the indicator light is disposed upon one of the ventilator, headboard or footboard.

6. The apparatus according to claim 1 wherein said indicator light is a light display remote from the enclosure.

7. The apparatus according to claim 6 wherein the circuit comprises a wireless transmitter for transmitting a signal to activate the light.

8. The apparatus according to claim 1 further comprising a memory device for storing positional information comprising at least a predetermined angular measurement.

9. The apparatus of claim 8 wherein the memory device further comprises a device for storing information pertaining to the length of time said patient support has been set to an angular position that is within a predetermined range.

10. The apparatus of claim 1 wherein the angle sensor is mounted to a portion of the bed frame that facilitates measurement of a pertinent angular position.

11. A method of determining the angular position of a patient support surface relative to the direction of gravity, comprising: the steps of:
providing an indicator light activated by an angle sensor mounted to a frame associated with the patient support surface, said indicator light being disposed on a post elevated above upon one of: a ventilator, a headboard or a footboard associated with the patient support surface; and
observing said indicator light from a position remote from said patient support by looking at said patient support whether the angular position is within a predetermined range.

12. (canceled)

13. The method of claim 11, wherein the step of observing a display comprises observing whether a light is displaying a first color or a second color.

14. The method of claim 11, wherein the step of observing a display comprises observing whether a light is turned on or turned off.

15. The method of claim 11, wherein the step of observing a display comprises observing an indication of a time period during which the patient support surface has been positioned within a predetermined range.

16. The method of claim 15, wherein the step of observing an indication of a time period comprises observing whether a light is turned on or turned off.

17. An method of indicating the angular position of a patient support surface relative to the direction of gravity, comprising:
mounting an angle sensor to a frame associated with the patient support surface;
creating an output responsive to changes in said angle sensor's position relative to gravity force;
transmitting an output signal to activate a display of the angular position of said patient support, wherein said display comprises a base, a post and a light disposed upon said post, wherein said display is placed upon a structure associated with the patient support surface and remote from the angle sensor; and
indicating on the display whether the angular position is within a predetermined range.

18. The method of claim 17, wherein the step of indicating on the display whether the angular position is within a predetermined range comprises turning a light on or off.

19. The method of claim 18 further comprising the step of mounting the light to one of a footboard or a headboard associated with the patient support surface.

20. The method of claim 18 further comprising the step of mounting the light at a remote location associated with the patient support surface.

21. The method of claim 17 further comprising the step of storing information pertaining to the length of time said patient support has been set to an angular position that is within the predetermined range.
